(19) United States
(12) Patent Application Publication
(10) Pub. No.: US 2024/0018344 A1
(43) Pub. Date: Jan. 18, 2024

(54) BIODEGRADABLE BIOPLASTIC

(71) Applicant: Board of Trustees of Western Michigan University, Kalamazoo, MI (US)

(72) Inventors: Abdus Salam, Kalamazoo, MI (US); Kecheng Li, Portage, MI (US)

(21) Appl. No.: 18/222,709

(22) Filed: Jul. 17, 2023

Related U.S. Application Data
(60) Provisional application No. 63/389,524, filed on Jul. 15, 2022.

(51) Int. Cl. C08L 3/02; C08L 1/02; C08K 5/20; D21H 19/52; D21H 19/54

(52) U.S. Cl. CPC C08L 3/02; C08L 1/02; C08K 5/20; D21H 19/52; D21H 19/54; C08L 2201/06; C08L 2201/10; C08L 2201/14; C08L 2203/16; C08L 2312/00

(57) ABSTRACT

A biodegradable bioplastic may be formed from starch or cellulose. A carbohydrate may be reacted with chloroacetamide and further reacted with one or more cross-linking agents to obtain a bioplastic material. The bioplastic material may be insoluble in water, and/or hydrophobic and/or substantially transparent. The bioplastic material may be formed into numerous shapes and structures. The bioplastic material may have high toughness, flexibility and/or moldability whereby the material is suitable for further processing into a wide variety of different shapes and structures. The bioplastic material may also be utilized as a barrier or coating on paper or other substrates for food packaging and other applications.

### CROSS REFERENCE TO RELATED APPLICATIONS

The present application claims the benefit under 35 USC § 119(e) to U.S. Provisional Patent Application No. 63/389,524, filed Jul. 15, 2022; the entire disclosure of that application is incorporated herein by reference.

### TECHNOLOGICAL FIELD

The disclosure relates to a biodegradable bioplastic and, more particularly, to a biodegradable bioplastic from synthesized starch derivatives for plastic-based products and coatings for food packaging applications and the like.

### BACKGROUND

There is considerable interest in bio-based plastics, with their theoretical potential of being biodegradable and made from renewable feedstocks. However, cost and other technical shortcomings have limited their use. The various petroleum-based plastic materials, such as polyethylene and others, are often cheaper than bio-based plastics but are usually not biodegradable. Known bio-based plastics, such as PLA (polylactic acid) tend to be expensive, and yet still do not meet the goal of ready biodegradability. The present disclosure discusses aspects and embodiments of starch-based bioplastics that solve the above issues with bio-based plastics of the prior art.

### SUMMARY

One aspect of the present disclosure is a biodegradable bioplastic that may be prepared from a synthesized starch derivative. In a non-limiting example, native corn starch can be applied to react with chloroacetamide and then further reacted with cross-linking agents and, preferably, a hydrophobic agent to obtain a bioplastic material. The bioplastic may be insoluble and/or hydrophobic and/or light-transmitting (e.g., transparent). A bioplastic material (e.g., film) according to an aspect of the present disclosure may have high toughness (e.g., similar to non-crystalline polypropylene) and/or high flexibility and/or high moldability. A bioplastic material according to an aspect of the present disclosure may be suitable for processing into a wide variety of shapes and structures. A bioplastic material according to an aspect of the present disclosure may, optionally, have high gloss, and may also, optionally, have a hydrophobicity similar to polyethylene (PE).

A bioplastic material according to an aspect of the present disclosure may be used for barrier coatings on paper, food packaging, or other materials. A bioplastic according to an aspect of the present disclosure may be insoluble in water and may also be highly hydrophobic. A bioplastic material according to an aspect of the present disclosure may also be cast and dried to obtain a thin or thick bioplastic film that may, optionally, be light-transmitting (e.g., transparent or partially transparent). Cellulose may be used as an alternative to starch in a bioplastic material according to another aspect of the present disclosure. A combination of cellulose and starch may also be utilized. However, these are merely examples of suitable raw materials that may be utilized to prepare bioplastic materials, and the present disclosure is not limited to those raw materials.

A starch-based (or cellulose-based) bioplastic film according to an aspect of the present disclosure may (optionally) have strong toughness, which may be similar to the toughness of non-crystalline polypropylene. A bioplastic film according to any aspect of the present disclosure may also (optionally) have sufficient flexibility and/or moldability to permit fabrication of a wide range of products from the bioplastic material.

Various products may be manufactured from a bioplastic material (e.g., a film) according to the present disclosure utilizing one or more suitable manufacturing processes such as casting, molding, or other suitable processes. In general, such processes may be scalable.

A bioplastic material according to an aspect of the present disclosure may comprise about 50% or more (e.g., 80%) material that is made from starch and/or cellulose. Materials and/or processes according to an aspect of the present disclosure may optionally utilize commercially available starch modifying agents and/or crosslinking reagents (or crosslinkers). A bioplastic material according to an aspect of the present disclosure may have a high degree of biodegradability (e.g., equal to or greater than 90%, 95%, 98%, or 99%), which may be defined as aerobic biodegradability in soil as determined in accordance with the ISO 17556.2003E standard.

A process for forming a starch-based and/or cellulose-based bioplastic according to an aspect of the present disclosure may be solvent-based and/or aqueous solution-based and may, therefore, be scalable. A process according to an aspect of the present disclosure may also be suitable for casting or molding plastic products such as films, containers (e.g., bottles), etc. A bioplastic material according to an aspect of the present disclosure may also be used as a bioplastic coating (e.g., liquid) on paper or other substrates to form hydrophobic or strongly hydrophobic material that may be used for food packaging and the like.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a flowchart showing a process for preparing bioplastic materials from raw materials;

FIG. 2 is a flowchart including images showing preparation of a synthesized starch-based bioplastic according to an aspect of the present disclosure;

FIGS. 3 (a)-(e) comprise images of a synthesized starch-based bioplastic (a)-(c) and contact angle of a drop of water on paper that has not (d) and has been coated with a bioplastic (e) according to an aspect and embodiment of the present disclosure, and (f)-(j) how a second, more-flexible aspect and embodiment bioplastic (f)-(h) coated on two papers (j), (k), showing the hydrophobicity of the bioplastic layer;

FIG. 4 is a graph showing X-ray diffraction (XRD) test results for starch, synthesized starch (modified starch), and synthetic polyethylene terephthalate (PET);

FIG. 5 is a graph showing thermogravimetric (TGA) test results for starch, synthesized starch (modified starch) and crosslinked modified starch, crosslinked with N-(hydroxymethyl) acrylamide, PAE, or glyoxal crosslinking agents;

FIG. 6 is a graph comparing the dynamic contact angle of different crosslinking agent-treated synthesized starches with added alkyl ketene dimer (AKD) hydrophobic agent and paper (Dixie-brand plate) treated with a commercial plastic coating agent (polyethylene);

FIG. 7 is a graph showing concentration optimization of acetamide at various concentrations of 2-chloroacetamide of modified starch according to aspects of the present disclosure;

FIG. 8 is a graph showing reaction time optimization of in modified starch according to aspects of the present disclosure;

FIG. 9 is a graph showing temperature optimization of modified starch according to aspects of the present disclosure;

FIG. 10 is a graph showing pH optimization of modified starch according to an aspect of the present disclosure;

FIG. 11 is a graph showing solid to liquor ratio optimization of modified starch according to aspects of the present disclosure;

FIG. 12 is a graph showing modified starch to glyoxal concentration optimization according to aspects of the present disclosure;

FIG. 13 is a graph showing modified starch to n-(hydroxymethyl) acrylamide concentration optimization according to aspects of the present disclosure;

FIG. 14 is a graph showing modified starch to PAE (polyamide epichlorohydrin) concentration optimization according to aspects of the present disclosure;

FIG. 15 is a graph showing modified starch+glyoxal reaction time optimization according to aspects of the present disclosure;

FIG. 16 is a graph showing modified starch+n-(hydroxymethyl) acrylamide reaction time optimization according to aspects of the present disclosure;

FIG. 17 is a graph showing modified starch+PAE reaction time optimization according to aspects of the present disclosure;

FIG. 18 is a graph showing modified starch+glyoxal temperature optimization according to aspects of the present disclosure;

FIG. 19 is a graph showing modified starch+n-(hydroxymethyl) acrylamide temperature optimization according to aspects of the present disclosure;

FIG. 20 is a graph showing modified starch+PAE temperature optimization according to aspects of the present disclosure;

FIG. 21 is a graph showing contact angle results for various concentrations of AKD added to modified starch+glyoxal according to aspects of the present disclosure;

FIG. 22 is a graph showing contact angle results for various concentrations of PDMS added to modified starch+glyoxal according to aspects of the present disclosure;

FIG. 23 is a graph showing contact angle results for various concentrations of zein added to modified starch+glyoxal according to aspects of the present disclosure;

FIG. 24 is a graph showing contact angle results for various concentrations of AKD added to modified starch+n-(hydroxymethyl) acrylamide according to aspects of the present disclosure;

FIG. 25 is a graph showing contact angle results for various concentrations of PDMS added to modified starch+n-(hydroxymethyl) acrylamide according to aspects of the present disclosure;

FIG. 26 is a graph showing contact angle results for various concentrations of zein added to modified starch+n-(hydroxymethyl) acrylamide according to aspects of the present disclosure;

FIG. 27 is a graph showing contact angle results for various concentrations of modified Starch+PAE and AKD according to aspects of the present disclosure;

FIG. 28 is a graph showing contact angle results for various concentrations of modified starch+PAE and PDMS according to aspects of the present disclosure; and

FIG. 29 is a graph showing contact angle results for various concentrations of modified starch+PAE and zein according to aspects of the present disclosure.

### DETAILED DESCRIPTION OF EMBODIMENTS

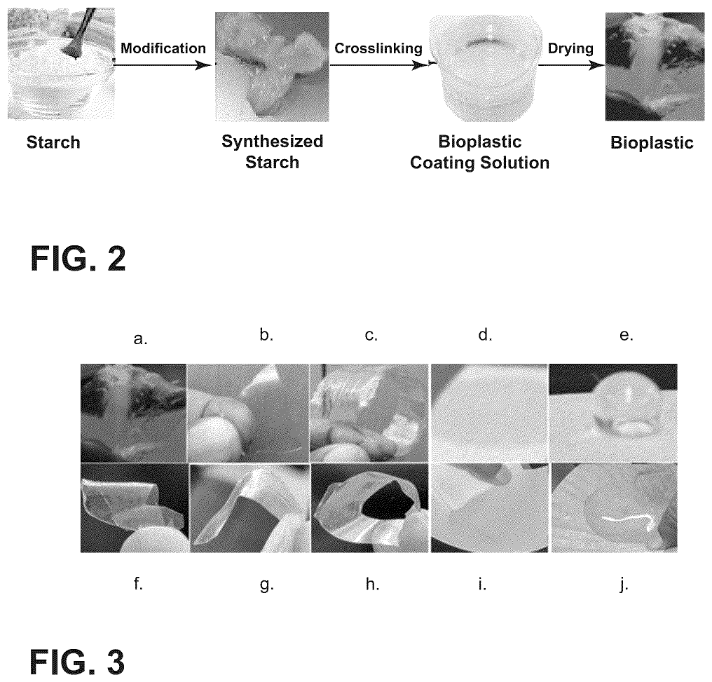

For purposes of description herein the terms “upper,” “lower,” “right,” “left,” “rear,” “front,” “vertical,” “horizontal,” and derivatives thereof shall relate to the disclosure as oriented in FIGS. 2-3. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

A biodegradable bioplastic material according to an aspect of the present disclosure may be prepared from a synthesized starch derivative. According to an aspect of the present disclosure, native cornstarch may be applied to react with chloroacetamide, and then further reacted with at least one crosslinking agent and, preferably, (but optionally) at least one hydrophobic agent to form a bioplastic material. The bioplastic material may be insoluble in water, hydrophobic, and transparent. A starch-based bioplastic film may be formed from the bioplastic material by casting or other suitable processes. A bioplastic material (e.g., film) according to an aspect of the present disclosure may have a high toughness that may be similar to non-crystalline polypropylene. Furthermore, a bioplastic material according to the present disclosure may provide a flexibility and/or moldability that is suitable for processing into various shapes and structures. A bioplastic material according to the present disclosure may have a high gloss and may also have a strong hydrophobicity that may be similar to polyethylene (PE).

Thus, a bioplastic material according to the present disclosure may be used as an alternative to petroleum-based plastic for many commercial plastic products that are not presently biodegradable. A bioplastic material according to the present disclosure may also be used to form a barrier coating on paper (e.g., for food packaging). Known barrier coatings may use petroleum-based materials that are not biodegradable.

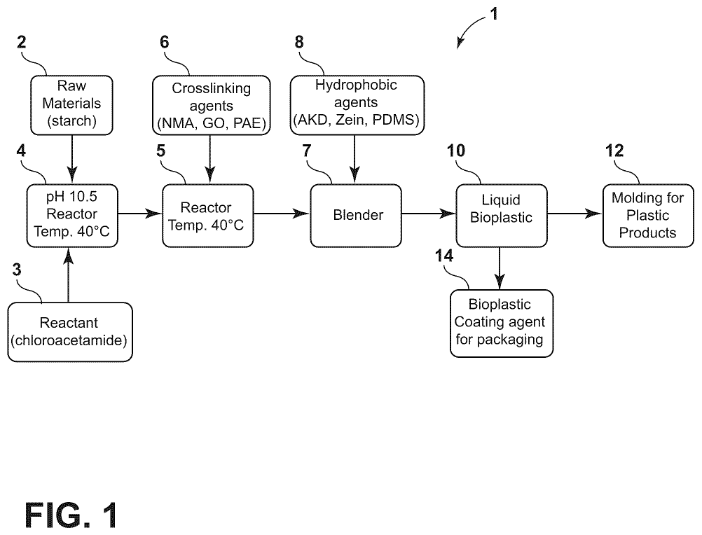

With reference to FIG. 1, an example of a process 1 according to an aspect of the present disclosure includes adding raw materials (starch) 2 and a reactant (chloroacetamide) 3 in a reactor at a first step 4. The pH in the reactor at first step 4 may be about 8.5 and the temperature may be about room temperature (e.g., about 22° C.). However, various ranges of pH may be utilized (e.g., 8.0-9.0, 8.0-10.0, 10.0-11.0, 9.5-11.5, etc.), and the present disclosure is not limited to any particular pH or range of pHs. Similarly, although the temperature during first step 4 may be about room temperature (e.g., 22-24° C.) as shown in FIG. 1, the present disclosure is not limited to a specific temperature, and the temperature may be significantly greater or less than the examples of FIG. 1 (e.g., 35° C.-45° C., 30° C.-50° C., 20° C.-60° C., etc.). At second step 5, the reactor temperature may, optionally be raised to about 70° C., and crosslinking agents (for example, n-(hydroxymethyl) acrylamide (NMA), glycoxal (GO), PAE) 6 may be added to the reactor. At third step 7, the temperature may be reduced to room temperature, and the material from the reactor is combined with hydrophobic agents (e.g., AKD, zein, PDMS) 8. This produces a liquid bioplastic 10 that may be molded into plastic products at step 12. Alternatively, the liquid bioplastic 10 may be utilized as a coating agent for packaging at step 14 (e.g., by coating paper or other packaging materials).

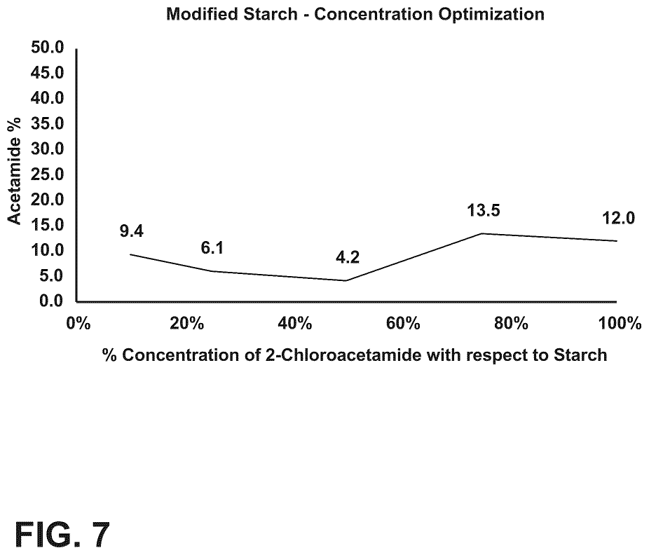

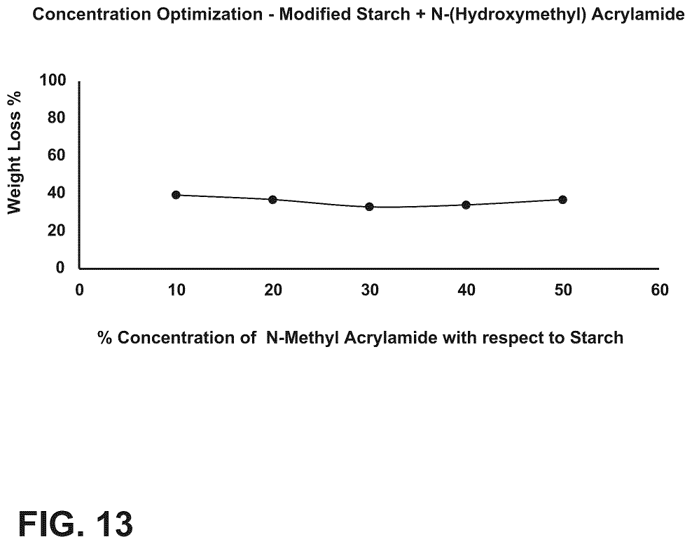

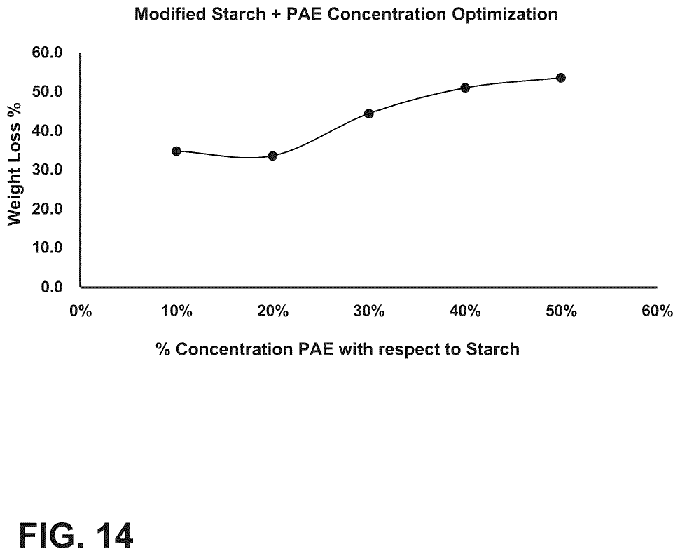

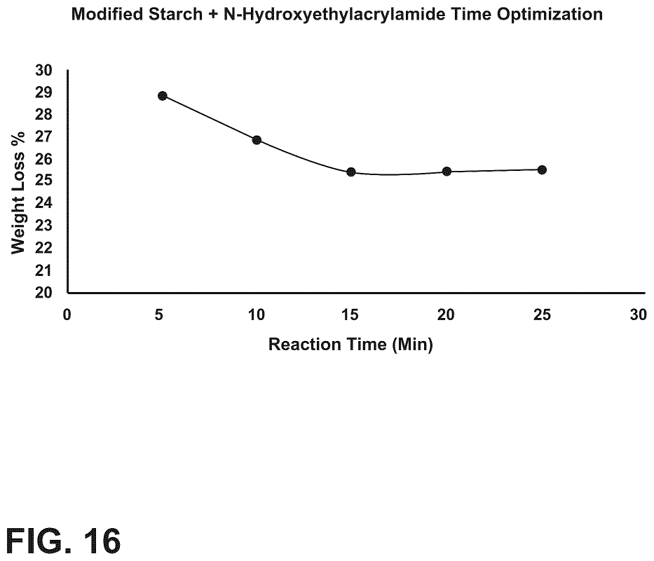

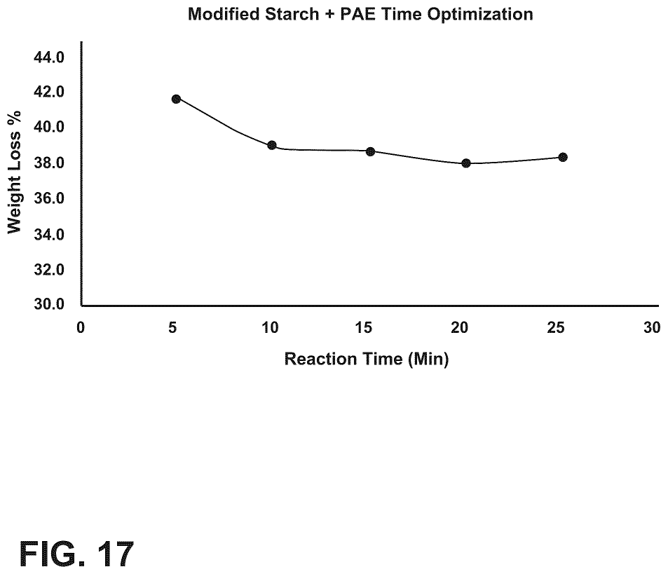

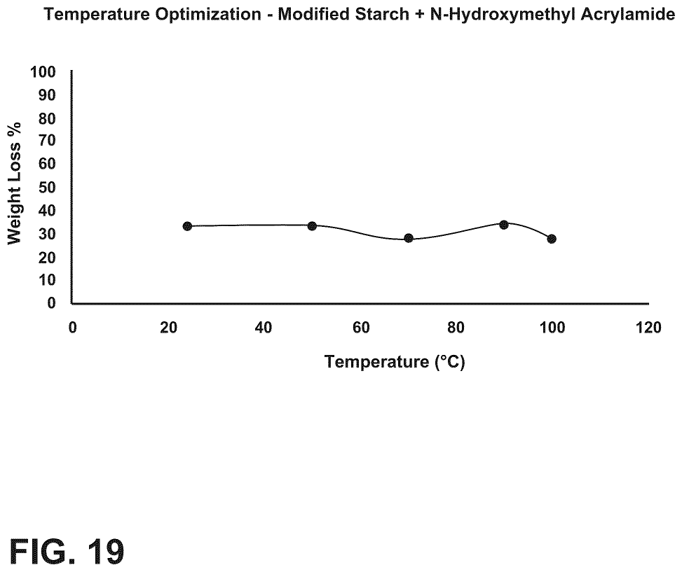

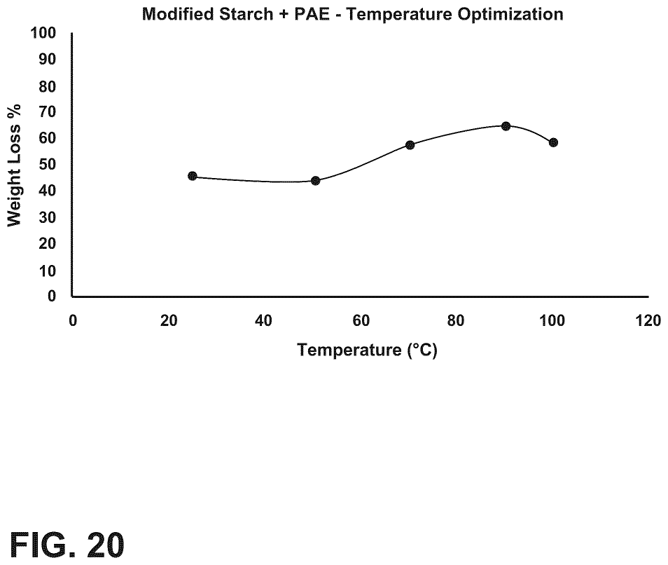

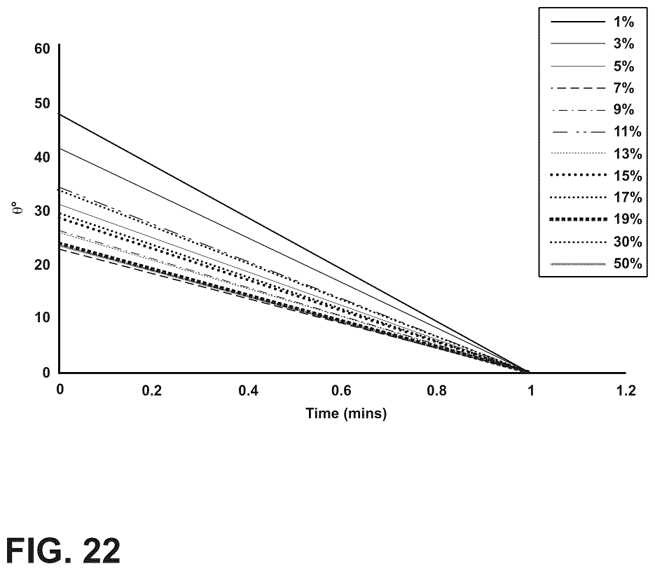

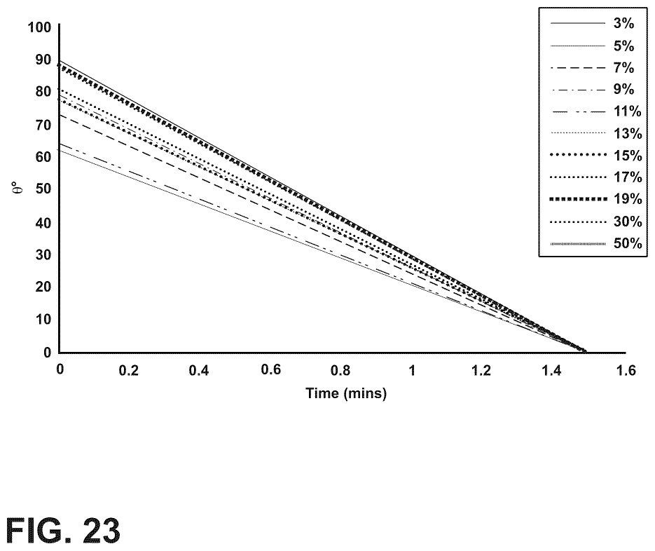

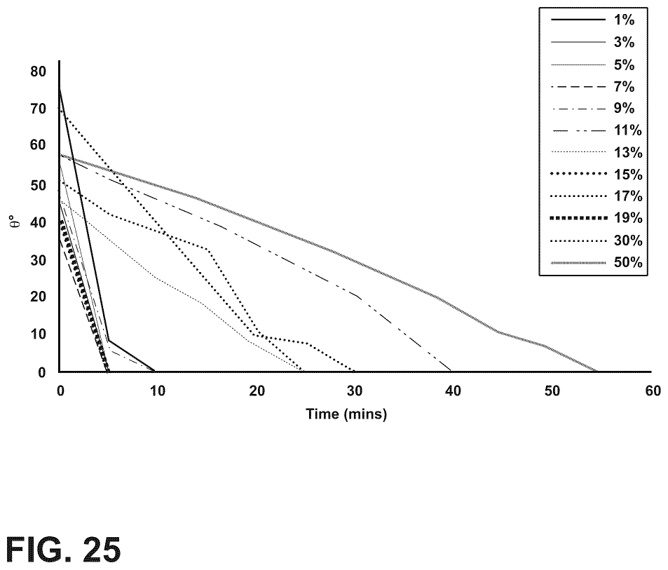

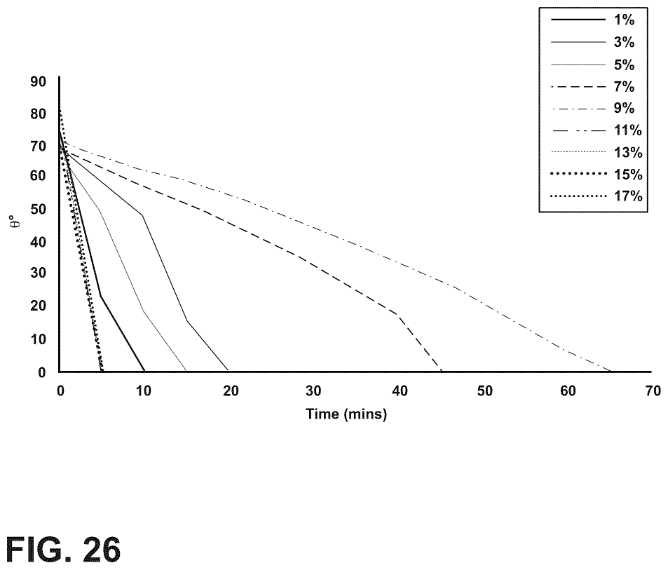

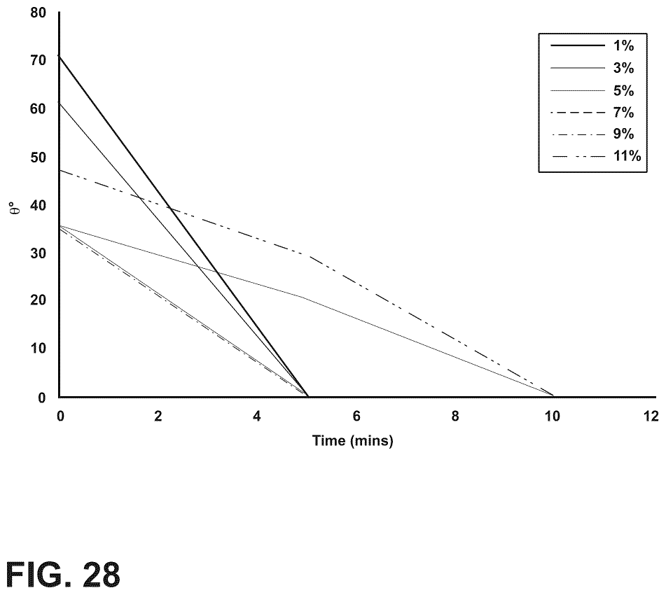

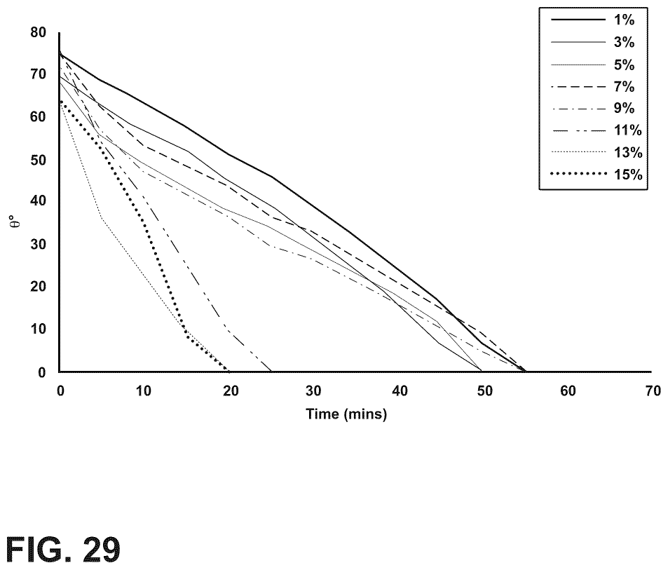

The materials, times, temperatures, pH, and other parameters may be adjusted or optimized as required for a particular application. Examples of various optimizations are discussed in more detail below in connection with FIGS. 7-30. In particular, the parameters of a process according to the present disclosure are not limited to the examples of FIG. 1.

Referring again to FIG. 1, for bioplastic preparation the materials may remain in the reactor during steps 4, 5, and 7 until liquid bioplastic 10 is produced. Thus, the reactants may be added to the reactor one after another in sequence. The time for first step 4 may be about 1-2 hours, and the time for the second step 5 may be about 45 minutes. For the third step 7 (i.e., addition of a hydrophobic agent), the material may remain in the reactor for about 30 minutes.

With further reference to FIG. 2, the process may include modifying starch to form synthesized starch. The synthesized starch is then cross linked to form a bioplastic coating solution which may then be dried to form a bioplastic. FIGS. 3a-c and 3e comprise photographs of a synthesized starch-based bioplastic, according to a first example aspect of the present disclosure (FIGS. 3a-3f). FIG. 3a shows the bioplastic, which may be molded into a flexible sheet (FIGS. 3b, 3c). To test the hydrophobicity of the bioplastic, the contact angle of a drop of water was noted after addition to untreated paper (FIG. 3d) and on paper that has been coated with a bioplastic according to an aspect of the present disclosure (FIG. 3e). The image of the beaded drop of water (FIG. 3e) shows that paper coated with a bioplastic according to an aspect of the present disclosure may be highly hydrophobic.

Similarly, FIGS. 3f-j show a second, more-flexible embodiment of the present disclosure (FIGS. 3f-3h) coated onto two different types of paper (FIGS. 3i and 3j) showing the hydrophobicilty of the bioplastic layer. The chart below shows various strength and extension parameters for the bioplastic show in FIGS. 3f-j, which are comparable or exceed specifications for a polypropylene plastic bag material of the same thickness.

| | | | | Exten- | Load/ | |
|---|---|---|---|---|---|---|
| | Width | Thickness | Load | sion | Thick- | Extension/ |
| Sample | (mm) | (mm) | (kgf) | (mm) | ness | Thickness |
| Synthesized | 7 | 0.06 | 1.442 | 1.37 | 24.03 | 22.83 |
| Starch- | | | | | | |
| bioplastic | | | | | | |
| film | | | | | | |
| Polyethylene | 7 | 0.05 | 0.8 | 10.78 | 16 | 215.6 |
| film (plastic | | | | | | |
| bag) | | | | | | |

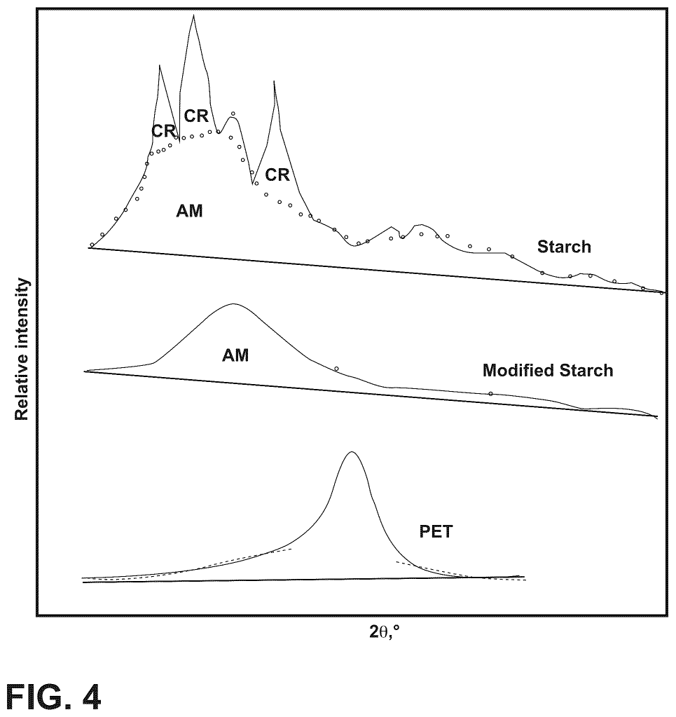

FIG. 4 is a graph showing X-ray diffraction (XRD) test results for starch, modified (synthesized) starch, and synthetic polyethylene terephthalate (PET). The XRD test results of FIG. 4 show that a modified starch according to an aspect of the present disclosure has a distinct XRD diffraction pattern relative to unmodified starch and PET. More specifically, the XRD test results of FIG. 4 show that a chemical modification to the raw materials (starch) according to an aspect of the present disclosure significantly or completely changed the crystallinity of the starch and produced a non-crystalline starch (modified starch). The modified starch has a melting temperature, and therefore comprises a thermoplastic material (bioplastic). Without wishing to be bound by a specific theory or explanation, the fact that the modified starch is non-crystalline (as is polyethylene terephthalate (PET)) may be related to the melting property of the modified starch.

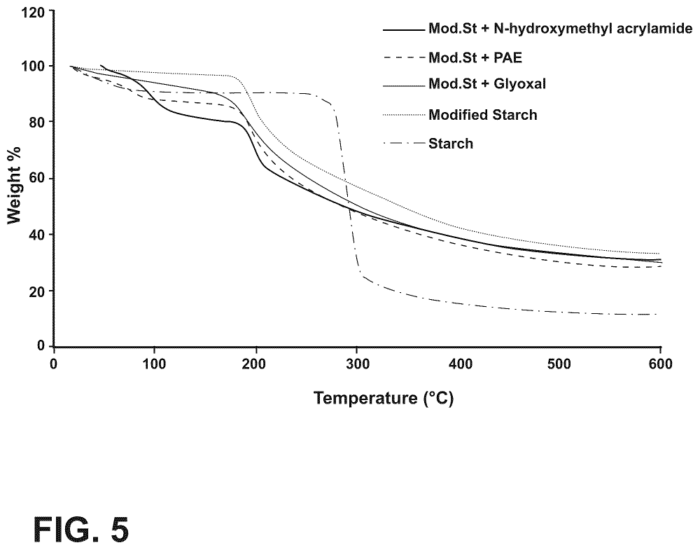

With further reference to FIG. 5, thermogravimetric (TGA) test results show that a modified starch according to various aspects of the present disclosure have a distinct weight percentage response as a function of increasing temperature relative to unmodified starch. In particular, the TGA test results of FIG. 5 show that a starch-based bioplastic according to the present disclosure has significant thermal stability.

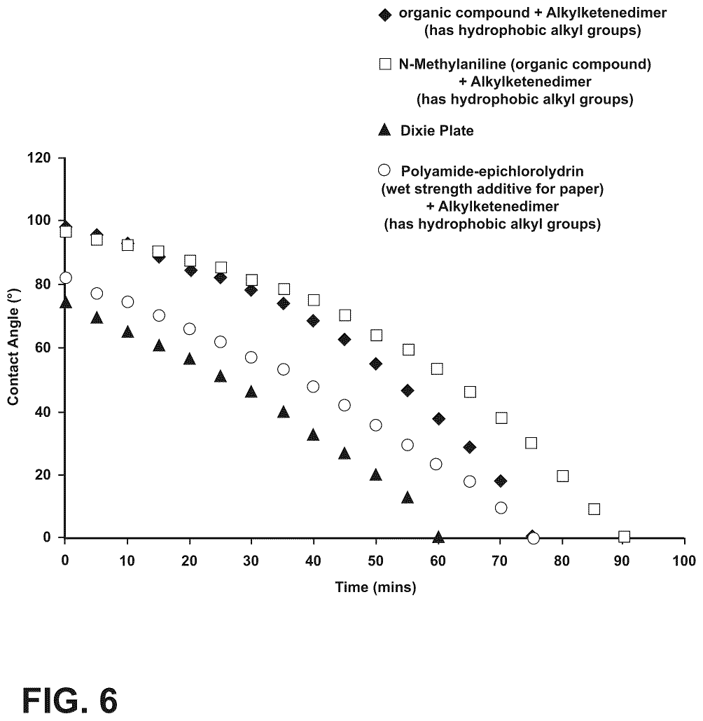

FIG. 6 shows that the contact angle of synthesized starch according to various aspects of the present disclosure is generally higher than paper (Dixie Plate) treated with a commercial plastic coating agent (polyethylene). Thus, synthesized starch treated with crosslinking agents such as NMA, GO, or PAE have greater hydrophobicity than paper treated (coated) with polyethylene.

As discussed above in connection with FIG. 1, a liquid bioplastic 10 according to an aspect of the present disclosure may be utilized as a coating agent for packaging applications and the like. Utilizing a bioplastic to coat material for packaging may comprise surface coating paper or other products (substrate) utilizing (for example) a paper coating machine (e.g., a paper mill) that coats the surface of the substrate with a liquid bioplastic formed from starch as described herein. Virtually any suitable coating machines and processes may be utilized to coat a substrate with a bioplastic according to the present disclosure.

As also discussed above in connection with FIG. 1, a bioplastic according to the present disclosure may also be formed or molded into various plastic products, such as solid or hollow 3D products. The molding step 12 may involve blow molding, solution molding, or other suitable processes. As discussed above, a bioplastic according to the present disclosure may comprise a thermoplastic material, and various processes utilized to mold thermoplastic materials may be utilized to mold a bioplastic according to the present disclosure.

A starch-based bioplastic according to an aspect of the present disclosure may be characterized by a degree of biodegradability of equal to or greater than, for example, 80%, 85%, 90%, 95%, or 98%, which refers to aerobic biodegradability in soil as determined in accordance with the ISO 17556.2003E standard.

A bioplastic material according to an aspect of the present disclosure may be formed from native cornstarch or cellulose, or other suitable carbohydrate. The carbohydrate is reacted with chloroacetamide to form modified starch, and further reacted with suitable crosslinking agents.

### Bioplastic Preparation:

The following is a non-limiting example of a process that may be utilized to synthesize a bioplastic according to an aspect of the present disclosure. First, about 5.0 g cornstarch may be dissolved with about 100 mL water in a reactor, and NaOH solution may be added to adjust the pH to about 8.5. The mixture may be stirred for about 10 minutes and then about 3.75 g of 2-chloroacetamide may be added to allow the reaction with cornstarch. The reaction mixture may continue to be stirred at about room temperature for about 1 hour and then raised to about 90° C. for about 15 minutes. This may be followed by ambient cooling to about 70° C. to form a modified cornstarch solution, and about 2 g of one or more suitable crosslinking agents (e.g., n-hydroxy methyl acrylamide and/or glyoxal and/or polyamide epichlorohydrin (PAE)) may then be slowly added separately into the modified cornstarch solution in the reactor. The mixture may continue to be stirred for about 30 more minutes, followed by ambient cooling to about room temperature (e.g., about 22-24° C.). About 0.25 g of suitable hydrophobic agents such as AKD or zein may then be added separately, and the mixture may then continue to be stirred for about 30 minutes to produce a liquid hydrophobic bioplastic. As discussed above, the liquid bioplastic solution can be used to make plastic structures or products by casting/molding. Alternatively, the liquid bioplastic solution may be used as a coating agent to form a water resistant or waterproof layer on various substrates (e.g., fiber-based substrates) for food packaging applications or the like. As discussed in more detail below, one or more of the parameters and/or materials (reactants) such as modifying agents, crosslinking agents and hydrophobic agents may be optimized.

As noted above, starch, cellulose or other carbohydrates may be used directly with cross-linking agents and the like for use in bioplastics in aspects of the present invention, or modified starch and other modified carbohydrates may be used as well.

### Bioplastic Preparation and Optimization Procedure:

Modification of cornstarch may be carried out in an aqueous medium by using a reactor. According to the following examples, five reaction conditions were optimized, including concentration of reactants, reaction temperature, reaction time, pH of reaction, and solid to liquor ratio. It will be understood that additional materials and parameters may also be adjusted or optimized as required for a particular application. Reaction conditions optimization may comprise changing one reaction condition (parameter or material) at a time, and then moving on to the next one, carrying over the best result from each factor being investigated.

In an example, the cornstarch was reacted with 2-chloroacetamide; five different proportions of 2-chloroacetamide were investigated based on the starch weight. The reaction time optimization was accomplished by varying reaction times between 0.5 hours and 7 hours. Reaction temperature optimization was accomplished by varying the reaction temperature from room temperature (i.e., 24° C.) to 80° C. In the examples discussed below, five different solid:liquor ratios and five different pH were also investigated. The proposed reaction is shown below:

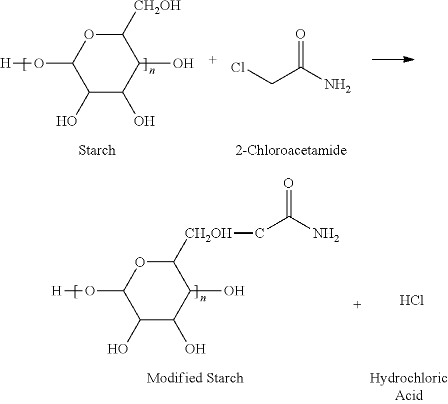

### Optimization of Reactant Concentration

To complete reaction conditions optimization, the reactant concentrations may be changed while keeping the following reaction conditions constant: 1) reaction time (e.g, 5 hours); 2) reaction temperature (e.g., 40° C.); 3) pH (e.g., 9.5); and 4) solid to liquor ratio (e.g., 1:30). The concentration of 2-chloroacetamide may be expressed in terms of a percentage with respect to starch weight. The concentrations of 2-chloroacetamide may be about 10%, 25%, 50%, 75%, 100%. The optimum concentration of 2-chloroacetamide may be determined based, at least in part, on the percentage of acetamide calculated from Fourier-Transform Infrared Spectroscopy (FTIR) for each concentration. FIG. 7 shows the result of the concentration optimization of modified starch. In this example, 75% of 2-chloroacetamide was chosen (determined) to be the optimum concentration based on the data obtained, providing a 13.5% acetamide percentage.

### Optimization of Reaction Time

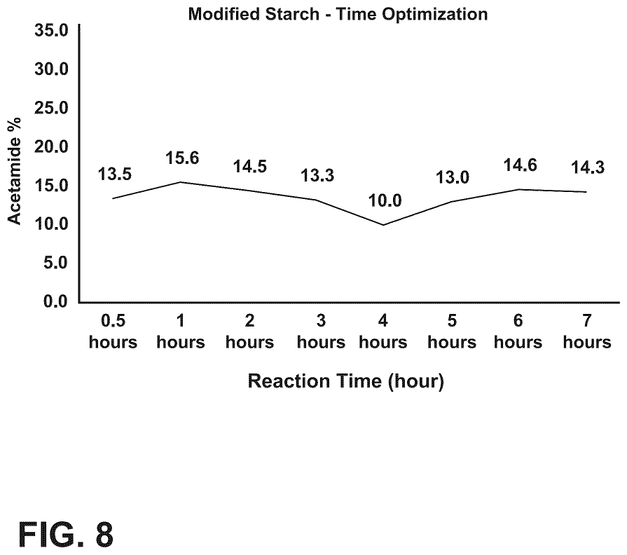

In this example, starch was reacted with 75% 2-chloroacetamide with respect to weight of starch, reaction temperature was 40° C., pH was 9.5, and the solid to liquor ratio was 1:30. The reaction time optimization was performed by varying the reaction times. Several reaction times were investigated, namely 0.5 hours, 1 hour, 2 hours, 3 hours, 4 hours, 5 hours, 6 hours, and 7 hours. The optimum time may be determined based, at least in part, on the percentage of acetamide calculated from using the FTIR method for each reaction time that is investigated. FIG. 8 shows the result of the reaction time optimization of modified starch. In this example, the optimum reaction time was chosen to be about 1 hour, based, at least in part, on the data obtained, providing an acetamide percentage of 15.6%.

### Optimization of Reaction Temperature

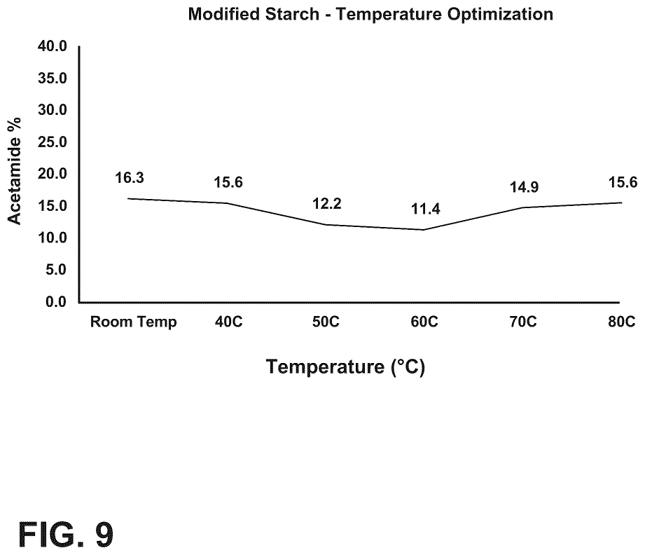

In this example, starch was reacted with 75% 2-chloroacetamide with respect to weight of starch, reaction time was 1 hour, pH was 9.5, and the solid to liquor ratio was 1:30. The reaction temperature optimization was carried out by investigating several reaction temperatures, namely room temperature (e.g., 24° C.), 40° C., 50° C., 60° C., 70° C., and 80° C. The optimum reaction temperature may be determined based, at least in part, on the percentage of acetamide calculated from using the FTIR method for each investigated reaction temperature. FIG. 9 shows the result of the reaction temperature optimization of modified starch. The optimum reaction temperature was determined to be room temperature, based on the data obtained, providing an acetamide percentage of 16.3%.

### Optimization of pH

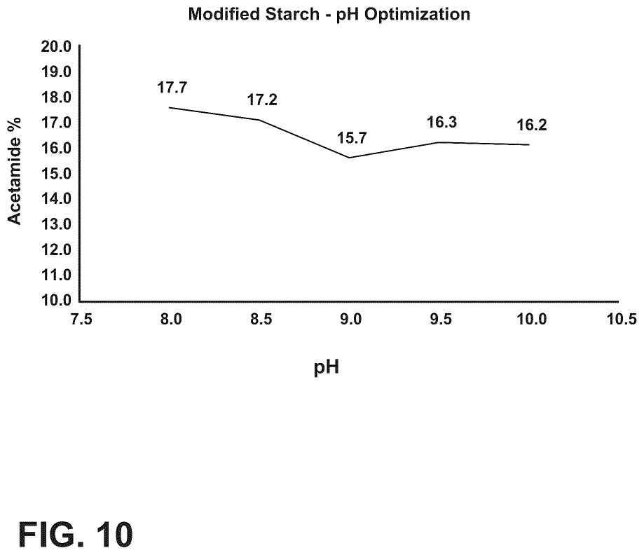

In this example, starch was reacted with 75% 2-chloroacetamide with respect to weight of starch, using a reaction time of 1 hour, and the reaction was carried out at room temperature, and the solid to liquor ratio was 1:30. The pH optimization was done by investigating several different pH, namely 8.0, 8.5, 9.0, 9.5, and 10.0. The optimum pH may be determined based, at least in part, on the percentage of acetamide calculated from using the FTIR method for each pH investigated. FIG. 10 shows the result of the pH optimization of modified starch. pH 8.0 was chosen as the optimum pH based on the data obtained, providing an acetamide percentage of 17.7%.

### Optimization of Solid to Liquor Ratio

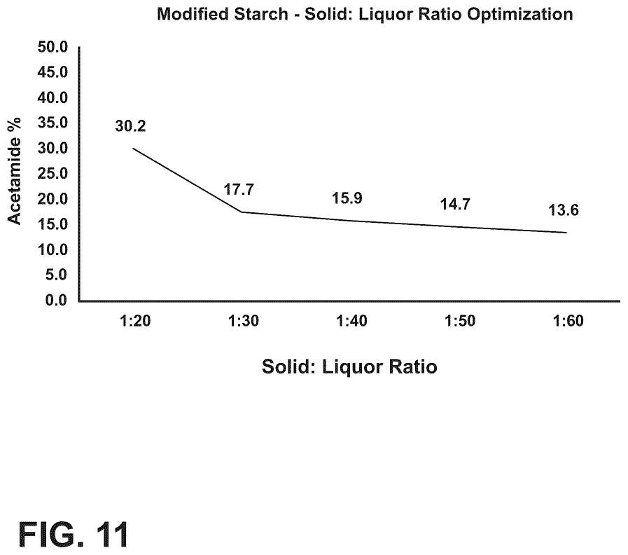

In this example, starch was reacted with 75% 2-chloroacetamide with respect to weight of starch, reaction time of 1 hour, the reaction was carried out at room temperature, and the reaction was carried out at pH 8.0. The solid to liquor optimization was conducted by varying solid to liquor ratios—1:10, 1:15, 1:20, 1:25, and 1:30. The optimum solid to liquor ratio was determined based, at least in part, on the percentage of acetamide calculated using the FTIR method for each ratio. FIG. 11 shows the result of the solid to liquor ratio optimization of modified starch. The ratio 1:20 was chosen as the optimum solid to liquor ratio based on the data obtained, providing a 30.2% acetamide percentage.

### Optimization of Reactant Concentration (Glyoxal, N-Hydroxymethyl Acrylamide and PAE)

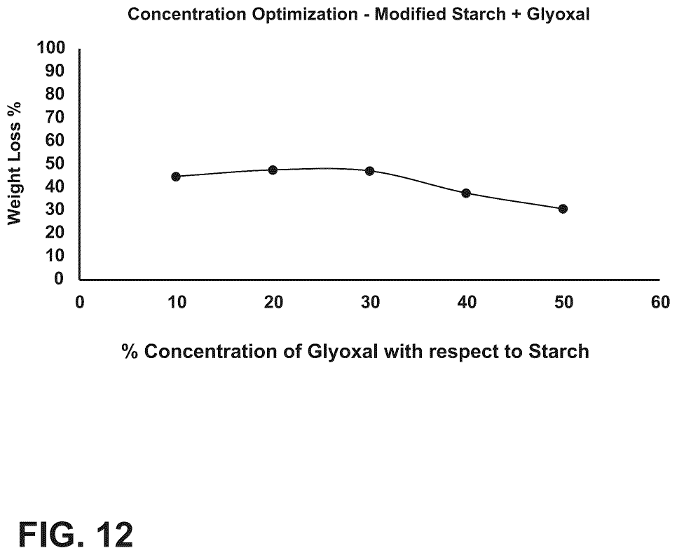

In this example, 50 mL of modified starch was reacted with three different cross-linking agents. Cross-linking agents were added to modified starch in concentrations of: 10%, 20%, 30%, 40%, 50% (add-on percentage). The resulting product was then oven dried overnight at 50° C. About 0.05-0.1 g of the oven dried sample was added to 100 mL of DI water and submerged for 18 hours. Vacuum filtration was then performed to separate the remaining sample from the DI water. The collected sample was then oven dried. By knowing the weight of the filter paper and the residue, the weight loss due to this process can be calculated. In this case, the weight loss is an indication with regards to the amount (quantity) of un-reacted substances. In particular, the reacted substances do not breakdown and dissolve in water. The difference in weight is therefore believed to be due to the unreacted substances being washed away during the filtration process. The results shown in FIGS. 12-14 suggest that the best add-on percentage for glyoxal is 50%, the best add-on percentage for N-(hydroxymethyl) acrylamide is 30%, and the best add-on percentage for PAE is 20%.

### Optimization of Reaction Time

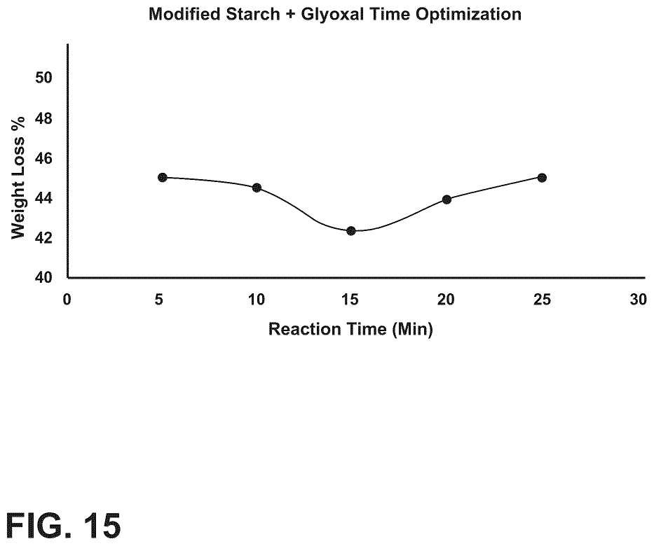

In this example, modified starch was reacted with three different cross-linking agents. Cross-linking agent were added to modified starch with constant concentration and temperature with varying reaction times. Reaction time optimization was initially carried out at times ranging from 20 minutes to 90 minutes. Initial testing showed that the reaction proceeded quickly. To get a more accurate result, the reaction was carried out at lower time durations of 5 min, 10 min, 15 min and 20 min. The optimum time was determined to be in the range of 15 minutes to 20 minutes for all three of the cross-linking agents. The same procedure described above was then utilized to determine the amount of weight loss to indicate how much of the reactants did not react (i.e., were washed away during filtration). The resulting product was then oven dried overnight at 50° C. About 0.05-0.1 g of oven-dried sample was then added to 100 mL of DI water and left for over 18 hours. The mixture was then filtered using a filter paper and vacuum. Weight loss was calculated by measuring before and after oven-dried weights Time optimization of modified starch and glyoxal,n-Hydroxymethyl acrylamide, PAE are shown in FIGS. 15, 16, and 17 respectively.

### Optimization of Reaction Temperature

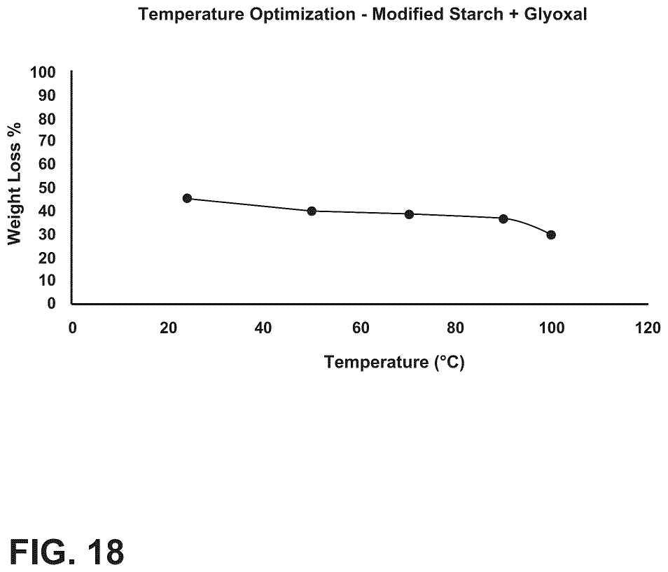

In this example, modified starch was reacted with three different cross-linking agents. Cross-linking agents were added to modified starch with constant concentration and time with variations of the temperature, namely room temperature (^{˜}24° C.), 50° C., 70° C., 90° C., 100° C. The same procedure described above was utilized to determine the amount of weight loss to indicate how much of the reactants did not react (i.e., were washed away during filtration). The resulting product was then oven dried overnight at 50° C. About 0.05-0.1 g of oven dried sample was added to 100 ml of DI water and left for over 18 hours to observe for weight loss. The mixture was then filtered using a filter paper and vacuum. Weight loss was calculated by measuring before and after oven dried weights. Temperature optimization of modified starch and glyoxal, n-hydroxymethyl acrylamide, and PAE are shown in FIGS. 18, 19, and 20, respectively.

### Hydrophobic Agent Optimizing Conditions

The contact angle may be determined by using a camera that is operably connected to a computer running suitable software (e.g., FTA 32). The liquid used for the test was DI water. A droplet of the liquid was dropped onto the surface of the treated surface of the blotter paper and the droplet was observed until the water droplet was completely evaporated, or absorbed by the paper.

### Optimization of Modified Starch+Glyoxal+Hydrophobic Agent

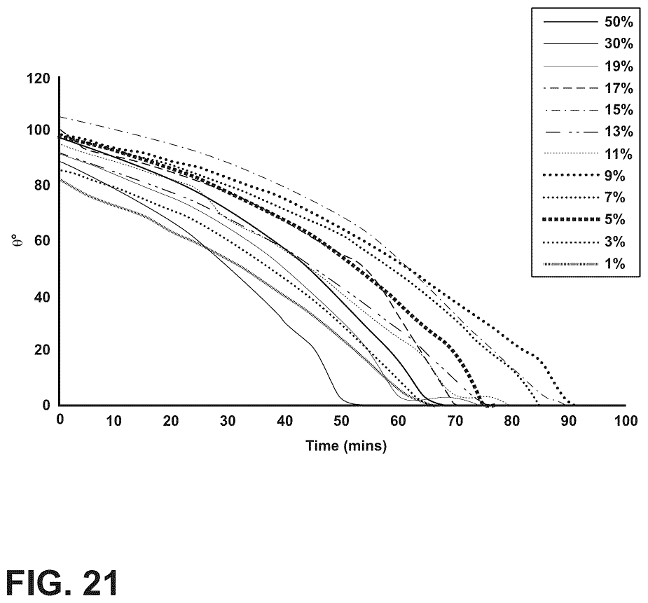

As discussed above, the effects of three different hydrophobic agents were investigated to determine the affect of the agents with regards to the performance of a bioplastic coating according to the present disclosure. The following is a discussion of the results obtained from adding the hydrophobic agents at several add-on percentages to the modified starch that contains glyoxal as the cross-linking agent. FIGS. 21, 22, and 23 show the contact angle results from modified starch+glyoxal and AKD, modified starch+glyoxal+PDMS, and modified starch+glyoxal+zein, respectively.

The results shown in FIGS. 21, 22 and 23 suggest that modified starch+Glyoxal+AKD performed the best (i.e., had the greatest hydrophobicity over time). FIG. 21 shows that, in this test, the initial contact angle for modified starch+Glyoxal+AKD was always at least 80° and could withhold water droplet absorption up to 90 minutes. Typically, the water droplet does not penetrate the treated surface. However, the water droplet may evaporate over time causing a decrease in the recorded contact angle. When the water evaporates completely, the recorded contact angle is zero and the test stops.

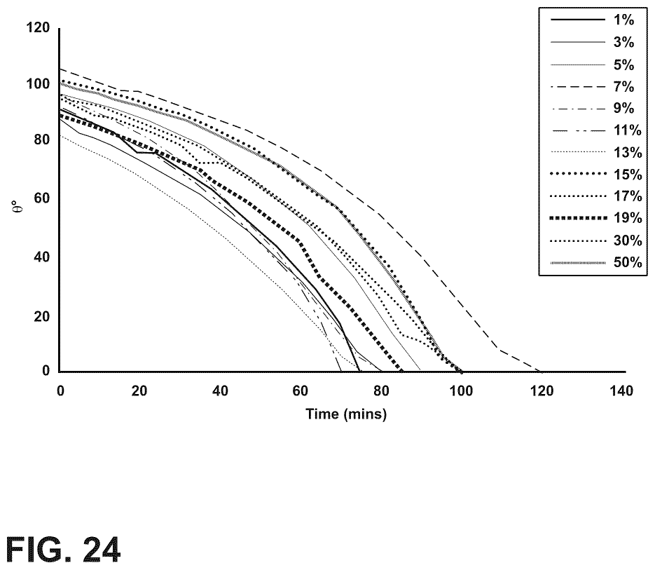

However, in these tests, the performance of modified starch+Glyoxal+PDMS, and modified starch+Glyoxal+zein, was lower. It is typically possible to record a high initial contact angle for these hydrophobic agents but after approximately 1 minute, the water droplet typically penetrates the coating, and the droplet is absorbed in to the blotter paper. FIG. 24 shows how, in this test, the shape of the water droplet changed over time on the treated surface.

### Modified Starch+n-(Hydroxymethyl) Acrylamide+Hydrophobic Agent

This section discusses the results obtained from adding the hydrophobic agents at several add-on percentages to the modified starch that contains N-(hydroxymethyl) acrylamide as the cross-linking agent. FIGS. 24, 25 and 26 show the contact angle results for modified starch+N-(hydroxymethyl) acrylamide+AKD, modified starch+N-(hydroxymethyl) acrylamide+PDMS, and modified starch+N-(hydroxymethyl) acrylamide+zein, respectively.

FIGS. 24, 25 and 26 suggest that modified starch+N-(hydroxymethyl) acrylamide+AKD performed the best. FIG. 24 shows that, in these tests, the initial contact angle for modified starch+N-(hydroxymethyl) acrylamide+AKD was always at least 80° and can withhold the water droplet up to 120 minutes. Typically, the water droplet does not penetrate the treated surface. However, the water droplet typically evaporates over time, causing a decrease in the recorded contact angle. When the water evaporates completely, the recorded contact angle is zero and the test may be stopped. However, for modified starch+N-(hydroxymethyl) acrylamide+PDMS, and modified starch+N-(hydroxymethyl) acrylamide+zein, the performance of the coating shows significant variation. Their ability to withhold the water droplet ranges from several minutes up to approximately one hour. The initial contact angle also varies significantly.

### Modified Starch+PAE+Hydrophobic Agent

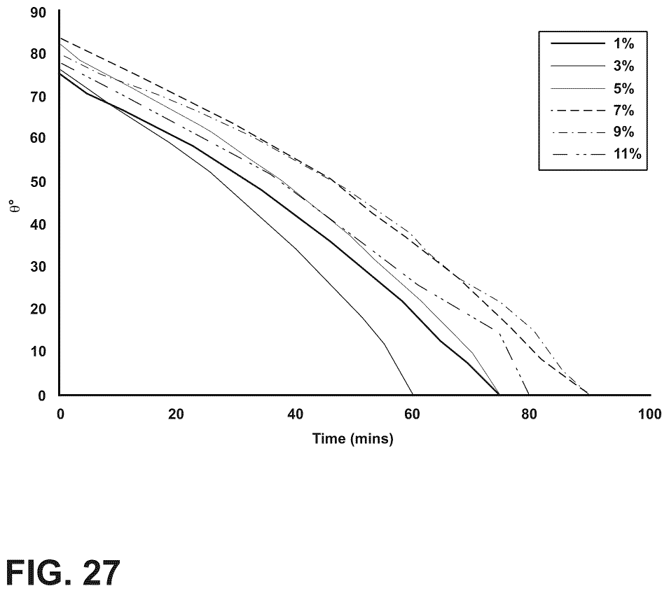

This section discusses the result obtained from adding the hydrophobic agents at several add-on percentages to the modified starch that contains PAE as the cross-linking agent. FIGS. 27, 28 and 29 show the contact angle results from modified starch+PAE+AKD, modified starch+PAE+PDMS, and modified starch+PAE+zein, respectively.

FIGS. 27, 28 and 29 show that modified starch+PAE+AKD performed the best. FIG. 27 shows that the initial contact angle for modified starch+PAE+AKD was always at least 75° in these tests, and could withhold the water droplet up to 90 minutes. Typically, the water droplet did not penetrate the treated surface in these tests. However, the water droplet typically evaporated over time, causing a decrease in the recorded contact angle. When the water evaporates completely, the recorded contact angle is zero and the test may be stopped. In these tests, modified starch+PAE+zein also showed some water resistance (hydrophobicity). It has an initial contact angle around 70° and it was able to withhold the water droplet for up to 55 minutes. However, in these tests, modified starch+PAE+PDMS did not perform as well as the other two. The results appear to be at least somewhat inconsistent, and the maximum duration it can withhold the water droplet is only 10 minutes.

### Performance of AKD

The results discussed herein show that out of the three hydrophobic agents tested, AKD has the best performance both in terms of initial contact angle (initial hydrophobicity) and the ability to withhold a water droplet over time. A 5% add-on percentage of AKD to the modified starch may be sufficient to achieve acceptable results, while reducing costs.

FIG. 6 (also discussed above) compares the performance between modified starch+Glyoxal+AKD, modified starch+n-(hydroxymethyl) acrylamide+AKD, modified starch+PAE+AKD, and also compares these to a commercially available treated-paper Dixie plate. The results show that all three coatings that contain AKD perform better than the Dixie plate. The Dixie plate has an initial contact angle of approximately 70° and can withhold a droplet of water for 60 minutes. However, a coating according to the present disclosure may have an initial contact angle of up to 100° and may withhold a water droplet for at least 90 minutes.

It will be understood that the present disclosure is not limited to the specific raw materials, cross-linking agents, and hydrophobic agents described above. Furthermore, the present disclosure is not limited to any specific combination of materials or parameters. For example, any of the ranges of parameters disclosed in any one of FIGS. 7-29 may be utilized in any combination with any other range disclosed in any of FIGS. 7-29. Furthermore, it will be understood that the ranges and other information disclosed in connection with FIGS. 7-29 are merely examples of ranges that may be utilized according to some aspects of the present disclosure, but the present disclosure is not limited to these specific ranges.

As discussed above, a bioplastic material according to the present disclosure may be formed into a wide range of shapes and products. For example, a bioplastic material according to the present disclosure may be cast or otherwise formed into a thin film, or into a thick film. In general, a thin film may have a thickness of about 1 nm to about 3 mm, and a thick film may have a thickness that is greater than 3 millimeters. For example, a thick film may have a thickness of about 5 mm to about 100 mm or greater. Still further, a bioplastic material according to the present disclosure may be formed into solid shapes other than films if required for a particular application.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A method of forming an article, the method comprising:
synthesizing a biodegradable bioplastic from at least one carbohydrate material comprising molecule chains, wherein the at least one carbohydrate material is selected from the group consisting of starch and cellulose, and wherein synthesizing the biodegradable bioplastic includes reacting the at least one carbohydrate material with chloroacetamide followed by reacting the carbohydrate material with one or more cross-linking agents to thereby form a biodegradable bioplastic material;
forming an article, wherein forming an article includes at least one of: 1) coating a substrate with the biodegradable bioplastic material and/or 2) molding the biodegradable bioplastic material into a three-dimensional shape, wherein the three-dimensional shape includes at least one portion having a non-uniform thickness and/or curved surface.

2-4. (canceled)

5. The method of claim 1, including:
coating a substrate with the biodegradable bioplastic material while the biodegradable bioplastic material is in a liquid form.

6-9. (canceled)

10. The method of claim 1, wherein:
the biodegradable bioplastic material has a degree of biodegradability of at least 80% according to the ISO 7556.200E3 standard.

11-16. (canceled)

17. The method of claim 1, wherein:
the biodegradable bioplastic material is hydrophobic.

18. (canceled)

19. A biodegradable bioplastic material comprising at least one carbohydrate material comprising molecule chains, wherein the at least one carbohydrate material is selected from the group consisting of starch and cellulose, said molecule chains bonded with at least one acetamide group and crosslinked with one or more crosslinking agents.

20. The biodegradable bioplastic material of claim 19, wherein the material is formed into a film having a uniform thickness, and/or a three-dimensional shape including at least one portion having a non-uniform thickness and/or curved surface.

21. The biodegradable bioplastic material of claim 19, wherein the material is used to coat a substrate.

22. The biodegradable bioplastic material of claim 21, wherein the substrate is paper.

23. The biodegradable bioplastic material of claim 21, wherein the substrate comprises a sheet of material formed from wood pulp.

24. The biodegradable bioplastic material of claim 20, wherein the material forms a container.

25. The biodegradable bioplastic material of claim 24, wherein the container is a bottle.

26. The biodegradable bioplastic material of claim 19, wherein the biodegradable bioplastic material has a degree of biodegradability of at least 80% according to the ISO 7556.200E3 standard.

27. The biodegradable bioplastic material of claim 26 has a degree of biodegradability of at least 90% according to the ISO 7556.200E3 standard.

28. The biodegradable bioplastic material of claim 19, wherein the material has a high toughness.

29. The biodegradable bioplastic material of claim 28, wherein a sheet of the material has a load bearing capacity and improved extensibility relative to a polypropylene sheet of the same thickness.

30. The biodegradable bioplastic material of claim 19, wherein the cross-linking agent includes one or more of N-(hydroxymethyl) acrylamide, PAE (polyamide epichlorohydrin), or glyoxal.

31. The biodegradable bioplastic material of claim 19, further comprising a hydrophobic agent.

32. The biodegradable bioplastic material of claim 31, wherein the hydrophobic agent includes one or more of AKD, PDMS or zein.

33. A biodegradable coated paper, wherein the paper comprises a biodegradable bioplastic material, comprising at least one carbohydrate material comprising molecule chains, wherein the at least one carbohydrate material is selected from the group consisting of starch and cellulose, said molecule chains bonded with at least one acetamide group and crosslinked with one or more crosslinking agents.

34. The biodegradable coated paper of claim 33 wherein the biodegradable bioplastic material further comprises a hydrophobic agent.
